(19) United States
(12) Patent Application Publication
(10) Pub. No.: US 2004/0152837 A1
(43) Pub. Date: Aug. 5, 2004

(54) Homogeneously colored thermoplastic molding compositions

(76) Inventors: Thomas Braig, Dusseldorf (DE); Friedemann Paul, Bergisch Gladbach (DE); Holger Warth, Dormagen (DE)

Correspondence Address: BAYER POLYMERS LLC, 100 BAYER ROAD, PITTSBURGH, PA, 15205, US

(21) Appl. No.: 10/751,746

(22) Filed: Jan. 5, 2004

(30) Foreign Application Priority Data
Jan. 7, 2003 (DE) 10300110.7

(51) Int. Cl. C08L 51/00

(52) U.S. Cl. 525/67; 525/69

(57) ABSTRACT

A thermoplastic molding composition characterized in its color homogeneity is disclosed. The composition that is suitable for preparing automotive parts contains A) 4 to 80% of at least one polyalkylene terephthalate, B) 10 to 90% of at least one aromatic polycarbonate, C) 1.5 to 30% of at least one AES graft polymer, D) 0 to 54% of at least one mineral filler in particulate form, E) 0.01 to 10% of a coloring material and F) 0 to 10% of at least one functional additive, the percents, all occurrences being relative to the weight of the composition.

### FIELD OF THE INVENTION

The present invention relates to colored thermoplastic molding compositions and more particularly to impact resistant compositions containing polyalkylene terephthalate and polycarbonate mold.

### SUMMARY OF THE INVENTION

A thermoplastic molding composition characterized in its color homogeneity is disclosed. The composition that is suitable for preparing automotive parts contains A) 4 to 80% of at least one polyalkylene terephthalate, B) 10 to 90% of at least one aromatic polycarbonate, C) 1.5 to 30% of at least one AES graft polymer, D) 0 to 54% of at least one mineral filler in particulate form, E) 0.01 to 10% of a coloring material and F) 0 to 10% of at least one functional additive, the percents, all occurrences being relative to the weight of the composition.

### BACKGROUND OF THE INVENTION

Molding compositions modified with impact resistance, which contain partially crystalline polyesters, amorphous polycarbonates and graft copolymers are known. Such molding compositions are used for example in the automotive sector for molded parts such as bumpers, mudguards, radiator grilles, panels, rear panels, sills, spoilers, door handles, tank covers, coatings, horizontal components such as bonnets or roof elements, door modules or similar. The preconditions for use in automotive applications are high resistance to thermoforming, high flowability in the melt, good lacquer adhesion, high resistance to chemicals, high rigidity, high dimensional stability and high low-temperature toughness.

Molded parts of polyalkylene terephthalate/polycarbonate blends modified with impact resistance are normally lacquered with a coloring lacquer, known as the base lacquer. Before the application of the base lacquer, the molded parts can optionally also be coated with primer and/or filler. A transparent clear lacquer can also optionally be applied to the base lacquer. These systems are referred to below as top coat lacquered systems. In the top coat lacquered system, the natural color of the molding composition itself is immaterial, as it is colored by the base lacquer.

As an alternative to top coat lacquer systems, there are systems that are referred to below as penetration-dyed systems. In penetration-dyed systems, the color of the molded part in the application is determined by the color of the molded part itself, which means that penetration-dyed systems are not lacquered with a primer, filler or coloring base lacquer. However, the penetration-dyed systems may optionally be coated with a transparent clear lacquer. The advantage of penetration-dyed systems lies in the cost savings, as the processes of priming with primer and/or fillers and the lacquering with a coloring base lacquer and the associated drying are not required.

In penetration-dyed systems, however, there is no covering base lacquer to provide a UV blocking function. At best, a UV clear lacquer can block the majority of the damaging UV radiation from penetration-dyed systems. Molding compositions that are based on penetration-dyed systems must nevertheless have high UV stability, which means that impact resistance modifiers based on rubbers containing conjugated dienes, such as for example butadiene in ABS- or MBS rubbers, cannot be used.

Weather-resistant PC/polyester blends therefore use, for example, acrylate rubbers, as disclosed in DE-A1 3 302 124.

EP-B1 0 787 769 discloses the use of PC/polyester blends containing a combination of AES and acrylate rubbers to obtain molding compositions with improved weather-resistance and good toughness.

However in penetration-dyed systems, in addition to weather-resistance, the ability to be homogeneously colored is of very great importance. It is precisely when using PC/polyester blends modified with impact resistance containing acrylate impact resistance modifiers for injection molded parts, that undesirable inhomogeneity of color occurs, in which regularly-recurring lightly colored areas, together with heavily, or darker or more intensely-colored areas, are formed perpendicular to the direction of flow during the injection molding process. These are known as “tiger stripes”. For molded parts that are visible to the user in their final application such as for example the external bodywork of a motor vehicle—such as e.g. mudguards, bumpers, tailgate, panel, spoiler, air intake grille, bonnet, car roof—, motor vehicle interior, casing for electrical equipment, casing for electronic equipment, these tiger stripe effects are unacceptable.

The object was to develop homogeneously-colored polyalkylene terephthalate/polycarbonate molding compositions modified with impact resistance for applications in so-called penetration-dyed systems. Penetration-dyed systems place increased demands on homogeneous coloring of the molding compositions or molded parts.

Practical experience shows, that materials used for automotive applications may have large variations in the listed properties, depending on the actual area of use. However, the ability to be colored homogeneously is the decisive factor for applications in penetration-dyed systems. This ability to be colored homogeneously is a key criterion for the use of the material in penetration-dyed systems, in addition to the material properties already mentioned, such as for example the stiffness of the material, thermal stability and impact resistance at low temperatures.

### DETAILED DESCRIPTION OF THE INVENTION

Surprisingly, it was found that colored polyalkylene terephthalate/poly-carbonate blends modified with impact resistance by means of impact resistance modifiers based on graft copolymer compositions based on acrylonitrile/ethylene propylene rubbers/styrene (AES) may be produced, that result in molded parts having excellent coloring homogeneity. The molding compositions according to the invention are also characterized by high thermal stability, high melt flowability, good lacquer adhesion, high resistance to chemicals, high rigidity, high dimensional stability and high toughness at low-temperatures. As AES rubbers contain no double-bond groups, they are also UV-stable.

The invention provides compositions containing

A) 4 to 80, preferably 10 to 60, particularly preferably 12 to 40, in particular 19 to 29 wt. % of at least one polyalkylene terephthalate, preferably a polyethylene terephthalate or a polybutylene terephthalate, particularly preferably a polyethylene terephthalate,

B) 10 to 90, preferably 20 to 80, particularly preferably 25 to 55, in particular 30 to 50 wt. % of at least one aromatic polycarbonate,

C) 1.5 to 30, preferably 3 to 25, particularly preferably 6 to 20, in particular 8 to 17 wt. % of at least one AES graft polymer,

D) 0 to 54, preferably 3 to 34, particularly preferably 6 to 25, in particular 8 to 21 wt. % of at least one mineral filler in particle form,

E) 0.01 to 10 wt. %, preferably 0.05 to 6 wt. % particularly preferably 0.1 to 3 wt. % of at least one coloring agent,

F) 0 to 10 wt. %, preferably 0.05 to 3 wt. % particularly preferably 0.1 to 0.9 wt. % of at least one functional additive.

According to the invention, the compositions contain as component A one or a mixture of two or more different polyalkylene terephthalates. Polyalkylene terephthalates according to the invention are polyalkylene terephthalates, which are derived from terephthalic acid (or its reactive derivatives) and alkane diols, for example based on ethylene glycol, propylene glycol or butane diol. According to the invention, preferably polybutylene terephthalate, polytrimethylene terephthalate and/or polyethylene terephthalate, particularly preferably polybutylene terephthalate and/or polyethylene terephthalate, most preferably polyethylene terephthalate are used as component A.

Polyalkylene terephthalates according to the invention are reaction products of aromatic dicarboxylic acid or its reactive derivatives (e.g. dimethyl esters or anhydrides) and aliphatic, cycloaliphatic or araliphatic diols and mixtures of these reaction products.

Preferred polyalkylene terephthalates may be produced from terephthalic acid (or its reactive derivatives) and aliphatic or cycloaliphatic diols having 2 to 10 C atoms by known methods (Kunststoff-Handbuch, Vol. VIII, p. 695 ff, Karl-Hanser-Verlag, Munich 1973).

Preferred polyalkylene terephthalates contain at least 80, preferably 90 mol. %, in relation to the dicarboxylic acid, of terephthalic acid groups and at least 80, preferably at least 90 mol. %, in relation to the diol component, of ethylene glycol- and/or propane diol-1,3- and/or butane diol-1,4 groups.

The preferred polyalkylene terephthalates may contain, in addition to terephthalic acid groups, up to 20 mol. % of groups of other aromatic dicarboxylic acids having 8 to 14 C atoms or aliphatic dicarboxylic acids having 4 to 12 C atoms, such as groups of phthalic acid, isophthalic acid, naphthaline-2,6-dicarboxylic acid, 4,4′-diphenyl dicarboxylic acid, succinic-, adipic-, sebacic acid, azelaic acid, cyclohexane diacetic acid, cyclohexane dicarboxylic acid.

The preferred polyalkylene terephthalates may contain, in addition to ethylene- or propane diol-1,3- or butane diol-1,4-glycol groups, up to 20 mol. % of other aliphatic diols having 3 to 12 C atoms or cycloaliphatic diols having 6 to 21 C atoms, e.g. groups of propane diol-1,3, 2-ethyl propane diol-1,3, neopentyl glycol, pentane diol-1,5, hexane diol-1,6, cyclohexane-dimethanol-1,4, 3-methyl pentane diol-2,4 2-methyl pentane diol-2,4, 2,2,4-trimethyl pentane diol-1,3, and -1,6,2-ethyl hexane diol-1,3, 2,2-diethyl propane diol-1,3, hexane diol-2,5, 1,4-di-(β-hydroxy-ethoxy)-benzene, 2,2-bis-(4-hydroxy-cyclohexyl)-propane, 2,4-dihydroxy-1,1,3,3-tetramethyl cyclobutane, 2,2-bis-(3-β-hydroxy-ethoxy-phenyl)-propane and 2,2-bis-(4-hydroxy-propoxy-phenyl)-propane (DE-A 24 07 674, 24 07 776, 27 15 932).

The polyalkylene terephthalates may be branched by incorporating relatively small quantities of 3- or 4-valent alcohols or 3- or 4-basic carboxylic acids, as disclosed e.g. in DE-A 19 00 270 and U.S. Pat. No. 3,692,744. Examples of preferred branching agents are trimesic acid, trimellitic acid, trimethylol ethane and—propane and pentaerythritol.

It is advisable to use no more than 1 mol. % of the branching agent in relation to the acid component.

Polyalkylene terephthalates, which have been produced solely from terephthalic acid and its reactive derivatives (e.g. its dialkyl esters) and ethylene glycol and/or propane diol-1,3 and/or butane diol-1,4 (polyethylene- and polybutylene terephthalate) and mixtures of these polyalkylene terephthalates, are preferred in particular.

Preferred polyalkylene terephthalates are also copolyesters, which are produced from at least two of the above-mentioned acid components and/or from at least two of the above-mentioned alcohol components, particularly preferred copolyesters are poly-(ethylene glycol/butane diol-1,4)-terephthalates.

The polyalkylene terephthalates generally have an intrinsic viscosity of ca 0.4 to 1.5, preferably 0.5 to 1.3, measured in each case in phenol/o-dichloro benzene (1:1 wt. %) at 25° C.

The polyesters manufactured according to the invention are preferably also used in mixture with other polyesters and/or other polymers. Mixtures of polyalkylene terephthalates with other polyesters are particularly preferred, mixtures of polybutylene terephthalate with polyethylene terephthalate are most particularly preferred.

Conventional additives such as e.g. mold-release agents, stabilizers, and/or flowing agents may be admixed in the melt or applied to the surface.

According to the invention, the compositions according to the invention contain as component B a polycarbonate or a mixture of polycarbonates.

Preferred polycarbonates are those homopolycarbonates and copolycarbonates based on bisphenols of the general formula (I),

HO-Z-OH (I)

in which Z is a divalent organic group having 6 to 30 C atoms, which contains one or more aromatic groups.

Bisphenols of formula (Ia) are preferred

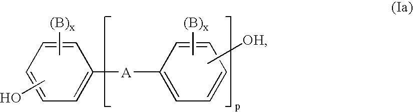

wherein

A means a single bond, C₁-C₅-alkylene, C₂-C₅-alkylidene, C₅-C₆-cycloalkylidene, —O—, —SO—, —CO—, —S—, —SO₂—, C₆-C₁₂-arylene, on to which other aromatic rings optionally containing heteroatoms may be condensed, or a group of formula (II) or (III)

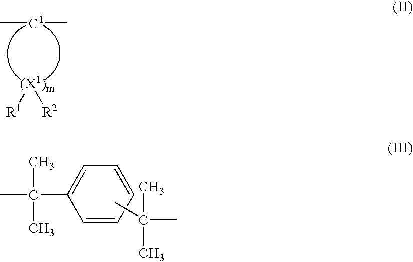

B is in each case C₁-C₁₂-alkyl, preferably methyl, halogen, preferably, chlorine and/or bromine

x is in each case, independently of the other, 0, 1 or 2,

p is 1 or 0, and

R¹ and R² are selected individually for each X¹, and independently of each other, denote hydrogen or C₁-C₆-alkyl, preferably hydrogen, methyl or ethyl,

X¹ means carbon and

m means an integer from 4 to 7, preferably 4 or 5, with the proviso that, on at lest one atom X¹, R¹ and R² are simultaneously alkyl.

Examples of bisphenols according to the general formula (I) are bisphenols, which belong to the following groups: dihydroxy diphenyls, bis-(hydroxyphenyl)-alkanes, bis-(hydroxyphenyl)-cycloalkanes, indane bisphenols, bis-(hydroxy-phenyl)-sulfides, bis-(hydroxyphenyl)-ethers, bis-(hydroxyphenyl)-ketones, bis-(hydroxyphenyl)-sulfones, bis-(hydroxyphenyl)-sulfoxides and α,α′-bis-(hydroxyphenyl)-diisopropyl benzenes.

Derivatives of the stated bisphenols, which are accessible for example by alkylation or halogenation on the aromatic rings of the stated bisphenols, are examples of bisphenols according to the general formula (I).

Examples of bisphenols according to the general formula (I) are, in particular, the following compounds: hydroquinone, resorcinol, 4,4′-dihydroxy diphenyl, bis-(4 hydroxyphenyl)sulfide, bis-(4-hydroxyphenyl)sulfone, bis-(3,5-dimethyl-4-hydroxy-phenyl)-methane, bis-(3,5-dimethyl-4-hydroxyphenyl)-sulfone, 1,1-bis-(3,5-dimethyl-4-hydroxyphenyl)-p/m-diisopropyl benzene, 1,1-bis-(4-hydroxyphenyl)-1-phenyl-ethane, 1,1-bis-(3,5-dimethyl-4-hydroxyphenyl)-cyclohexane, 1,1-bis-(4-hydroxyphenyl)-3-methyl cyclohexane, 1,1-bis-(4-hydroxyphenyl)-3,3-dimethyl cyclohexane, 1,1-bis-(4-hydroxyphenyl)-4-methyl cyclohexane, 1,1-bis-(4-hydroxyphenyl)-cyclohexane, 1,1-bis-(4-hydroxyphenyl)-3,3,5-trimethyl cyclohexane, 2,2-bis-(3,5-dichloro-4-hydroxyphenyl)-propane, 2,2-bis-(3-methyl-4-hydroxyphenyl)-propane, 2,2-bis-(3,5-dimethyl-4-hydroxyphenyl)-propane, 2,2-bis-(4-hydroxyphenyl)-propane (i.e. bisphenol A), 2,2-bis-(3-chloro-4-hydroxyphenyl)-propane, 2,2-bis-(3,5-dibromo-4-hydroxyphenyl)-propane, 2,4-bis-(4-hydroxyphenyl)-2-methyl butane, 2,4-bis-(3,5-dimethyl-4-hydroxyphenyl)-2-methyl butane, α,α′-bis-(4-hydroxyphenyl)-o-diisopropyl benzene, α,α′-bis-(4-hydroxyphenyl)-m-diisopropyl benzene (i.e. bisphenol M), α,α′-bis-(4-hydroxyphenyl)-p-diisopropyl benzene and indane bisphenol.

Particularly preferred polycarbonates are the homopolycarbonate based on bisphenol A, the homopolycarbonate based on 1,1-bis-(4-hydroxyphenyl)-3,3,5-trimethyl cyclohexane and the copolycarbonate based on the two monomers bisphenol A and 1,1-bis-(4-hydroxyphenyl)-3,3,5-trimethyl cyclohexane.

The bisphenols disclosed according to the general formula (I) may be produced by known processes, e.g. from the corresponding phenols and ketones.

The stated bisphenols and processes for producing them are disclosed for example in the monograph H. Schnell “Chemistry and Physics of Polycarbonates”, Polymer Reviews, Volume 9, p. 77-98, Interscience Publishers, New York, London, Sydney, 1964 and in U.S. Pat. No. 3,028,635, in U.S. Pat. No. 3,062,781, in U.S. Pat. No. 2,999,835, in U.S. Pat. No. 3,148,172, in U.S. Pat. No. 2,991,273, in U.S. Pat. No. 3,271,367, in U.S. Pat. No. 4,982,014, in U.S. Pat. No. 2,999,846, in DE-A 1 570 703, in DE-A 2 063 050, in DE-A 2 036 052, in DE-A 2 211 956, in DE-A 3 832 396, and in FR-A 1 561 518 as well as in the Japanese laid open specifications with the application numbers JP-A 62039 1986, JP-A 62040 1986 and JP-A 105550 1986.

1,1-bis-(4-hydroxyphenyl)-3,3,5-trimethyl cyclohexane and its production are disclosed e.g. in U.S. Pat. No. 4,982,014.

Indane bisphenols and their production are disclosed for example in U.S. Pat. No. 3,288,864, in JP-A 60 035 150 and in U.S. Pat. No. 4,334,106. Indane bisphenols may be produced, for example, from isopropenyl phenol or its derivatives or from dimers of isopropenyl phenol or its derivatives in the presence of a Friedel-Craft-Catalyst in organic solvents.

Polycarbonates may also be produced by known processes. Suitable processes for the production of polycarbonates are, for example, production from bisphenols with phosgene by the phase interface process or from bisphenols with phosgene by the homogeneous phase process, the so-called pyridine process, or from bisphenols with carbonic acid esters by the melt transesterification process. These production processes are disclosed e.g. in H. Schnell, “Chemistry and Physics of Polycarbonates”, Polymer Reviews, Volume 9, p. 31-76, Interscience Publishers, New York, London, Sydney, 1964. The stated production processes are also disclosed in D. Freitag, U. Grigo, P. R. Müller, H. Nouvertne “Polycarbonates” in Encyclopedia of Polymer Science and Engineering, Volume 11, Second Edition, 1988, pages 648 to 718 and in U. Grigo, K. Kircher and P. R. Müller “Polycarbonate” in Becker, Braun, Kunststoff-Handbuch, Volume 3/1, Polycarbonate, Polyacetale, Polyester, Celluloseester, Carl Hanser Verlag Munich, Vienna 1992, pages 117 to 299 and in D. C. Prevorsek, B. T. Debona and Y. Kesten, Corporate Research Center, Allied Chemical Corporation, Morristown, New Jersey 07960, “Synthesis of Poly(ester carbonate) Copolymers” in Journal of Polymer Science, Polymer Chemistry Edition, Vol. 9, 75-90 (1980).

The melt transesterification process is disclosed in particular in H. Schnell “Chemistry and Physics of Polycarbonates”, Polymer Reviews, Volume 9, p. 44 to 51, Interscience Publishers, New York, London, Sydney, 1964 and also in DE-A 1 031 512, in U.S. Pat. No. 3,022,272, in U.S. Pat. No. 5,340,905 and in U.S. Pat. No. 5,399,659.

When producing polycarbonate, raw materials and auxiliary substances with a low level of impurities are preferably used. In particular for production by the melt transesterification process, the bisphenols used and the carbonic acid derivatives used should be as free as possible from alkali ions and earth alkali ions. Such pure raw materials may be obtained, for example, by re-crystallising, washing or distilling the carbonic acid derivatives, for example carbonic acid esters, and the bisphenols.

The polycarbonates suitable according to the invention preferably have a weight average molecular weight (\overline{M}_{w}), which may be determined e.g. by ultracentrifugation or light scattering measurement, of 10 000 to 200 000 g/mol. Particularly preferably, they have a weight average molecular weight of 12 000 to 80 000 g/mol, in particular of 20 000 to 35 000 g/mol.

The average molecular weight of the polycarbonates according to the invention may be set, for example, in the known way by a corresponding quantity of chain stoppers. The chain stoppers may be used individually, or as a mixture of different chain stoppers.

Suitable chain stoppers are both monophenols and monocarboxylic acids. Suitable monophenols are e.g. phenol, p-chlorophenol, p-tert.-butyl phenol, cumyl phenol or 2,4,6-tribromophenol, and also long-chain alkyl phenols, such as e.g. 4-(1,1,3,3-tetramethylbutyl)-phenol or monoalkyl phenols or dialkyl phenols having a total of 8 to 20 C atoms in the alkyl substituents such as e.g. 3,5-di-tert.-butyl phenol, p-tert.-octyl phenol, p-dodecyl phenol, 2-(3,5-diemthyl-heptyl)-phenol or 4-(3,5-dimethyl-heptyl)-phenol. Suitable monocarboxylic acids are benzoic acids, alkyl benzoic acids and halogen benzoic acids.

Preferred chain stoppers are phenol, p-tert.-butyl phenol, 4-(1,1,3,3-tetramethyl butyl)-phenol and cumyl phenol.

The quantity of chain stoppers is preferably 0.25 to 10 mol. % in relation to the total of the bisphenols used in each case.

The polycarbonates suitable according to the invention may be branched in the known way, and preferably by incorporating branching agents having functionalities of three or greater. Suitable branching agents are e.g. those having three or more phenolic groups or those having three or more than three carboxylic acid groups.

Suitable branching agents are for example phloroglucinol, 4,6-dimethyl-2,4,6-tri-(4-hydroxyphenyl)-heptene-2, 4,6-dimethyl-2,4,6-tri-(4-hydroxyphenyl)-heptane, 1,3,5-tri-(4-hydroxyphenyl)-benzene, 1,1,1-tris-(4-hydroxyphenyl)-ethane, tri-(4-hydroxyphenyl)-phenyl methane, 2,2-bis-[4,4,-bis-(4-hydroxyphenyl)-cyclohexyl]-propane, 2,4-bis-(4-hydroxyphenyl-isopropyl)-phenol, 2,6-bis-(2-hydroxy-5′-methyl-benzyl)-4-methyl phenol, 2-(4-hydroxyphenyl)-2-(2,4-dihydroxyphenyl)-propane, hexa-(4-(4-hydroxyphenyl-isopropyl)-phenyl)-terephthalic acid ester, tetra-(4-hydroxyphenyl)-methane, tetra-(4-(4-hydroxyphenyl-isopropyl)-phenoxy)-methane and 1,4-bis-(4′,4″-dihydroxy triphenyl)-methyl benzene and also 2,4-dihydroxybenzoic acid ester, trimesic acid, cyanuric chloride, 3,3-bis(-3-methyl-4-hydroxyphenyl)-2-oxo-2,3-dihydro indol, trimesic acid trichloride and α,α′,α″-tris-(4-hydroxyphenol)-1,3,5-triisopropyl benzene.

Preferred branching agents are 1,1,1-tris-(4-hydroxyphenyl)-ethane and 3,3-bis-(3-methyl-4-hydroxyphenyl)-2-oxo-2,3-dihydro indol.

The quantity of the branching agents optionally to be used is preferably 0.05 mol% to 2 mol% in relation to mols of bisphenols used.

When producing the polycarbonate by the phase interface process for example, the branching agents may be provided with the bisphenols and the chain stoppers in the aqueous alkaline phase, or they may be added dissolved in an organic solvent together with the carbonic acid derivatives. When using the transesterification process, the branching agents are preferably dosed in together with the dihydroxy aromatics or bisphenols.

Preferred catalysts to be used for the production of polycarbonate by the melt transesterification process are the ammonium salts and phosphonium salts known from the literature (see for example U.S. Pat. No. 3,442,864, JP-A-14742/72, U.S. Pat. No. 5,399,659 and DE-A 19 539 290).

Copolycarbonates may also be used. Copolycarbonates according to the invention are, in particular, polydiorganosiloxane-polycarbonate block copolymers of which weight average molecular weight \overline{M}_{w} is preferably 10 000 to 200 000 g/mol, in particular 20 000 to 80 000 g/mol (determined by gel chromatography after prior calibration by light scattering measurement or ultracentrifugation). The content of aromatic carbonate structural elements in the polydiorganosiloxane-polycarbonate block copolymers is preferably 75 to 97.5 wt. %, in particular 85 to 97 wt. %. The content of polydiorganosiloxane structural elements in the polydiorganosiloxane-polycarbonate block copolymers is preferably 25 to 2.5 wt. %, in particular 15 to 3 wt. %. The polydiorganosiloxane -polycarbonate block copolymers may be produced, for example, on the basis of α,ω-bishydroxy aryloxy terminal group-containing polydiorganosiloxanes with an average degree of polymerisation of preferably Pₙ=5 to 100, in particular Pₙ=20 to 80.

The polydiorganosiloxane-polycarbonate block copolymers may also be a mixture of polydiorganosiloxane-polycarbonate block copolymers with conventional polysiloxane-free, thermoplastic polycarbonates, the total content of poly-diorganosiloxane structural elements in this mixture being preferably 2.5 to 25 wt. %.

Such polydiorganosiloxane-polycarbonate block copolymers are characterized in that they contain in the polymer chain on the one hand aromatic carbonate structural elements (1) and on the other hand aryloxy terminal group-containing polydiorganosiloxanes (2),

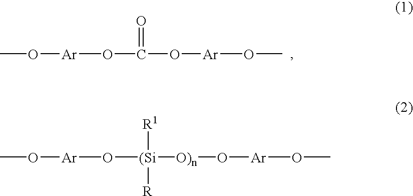

in which

Ar are the same or different difunctional aromatic groups and

R and R¹ are the same or different and mean linear alkyl, branched alkyl, alkenyl, halogenated linear alkyl, halogenated branched alkyl, aryl or halogenated aryl, preferably methyl, and

n means the average degree of polymerisation of preferably 5 to 100, in particular 20 to 80.

Alkyl in the above formula (2) is preferably C₁-C₂₀-alkyl, alkenyl in the above formula (2) is preferably C₂-C₆-alkenyl; aryl in the above formula (2) is preferably C₆-C₁₄-aryl. Halogenated in the above formula means partially or fully chlorinated, brominated or fluorinated.

Examples of alkyls, alkenyls, aryls, halogenated alkyls and halogenated aryls are methyl, ethyl, propyl, n-butyl, tert.-butyl, vinyl, phenyl, naphthyl, chloromethyl, perfluorobutyl, perfluorooctyl and chlorophenyl.

Such polydiorganosiloxane-polycarbonate block copolymers and their production are disclosed for example in U.S. Pat. No. 3,189,662, U.S. Pat. No. 3,821,325 and U.S. Pat. No. 3 832 419.

Preferred polydiorganosiloxane-polycarbonate block copolymers may be produced e.g. by reacting α,ω-bishydroxy aryloxy terminal group-containing polydiorganosiloxanes together with other bisphenols, optionally also using branching agents in the conventional quantities, e.g. by the two phase interface process (as disclosed for example in H. Schnell “Chemistry and Physics of Polycarbonates”, Polymer Reviews, Volume 9, p. 31-76, Interscience Publishers, New York, London, Sydney, 1964). The α,ω-bishydroxy aryloxy terminal group-containing polydiorganosiloxanes used for this synthesis and their production are disclosed for example in U.S. Pat. No. 3,419,634.

The polycarbonates may contain conventional additives such as e.g. mold release agents, admixed in the melt or applied to the surface. The polycarbonates used preferably already contain mold release agents before compounding with the other components of the molding compositions according to the invention.

According to the invention, one or a mixture of two or more graft copolymers are used as component C), which are obtained by copolymerization of a mixture of styrene and acrylonitrile on rubber backbone (=graft base) of a ethylene-propylene-copolymer (EPM) or a ethylene-propylene-unconjugated diene-copolymer (EPDM), and are designated AES rubbers.

The graft polymers used according to the invention in the compositions are those containing EP(D)M rubbers as the grafting base. The glass transition temperature of such rubbers may be0 to −60° C., they have only a small number of double bonds, for example less than 20 per 1000 carbon atoms. Copolymers or terpolymers containing at least one ethylene and propylene and preferably having only a small number of double bonds, for example, are used, for-which see EP-A 163 411 (corresponding to U.S. Pat. No. 4,550,138 incorporated herein by reference) and 244 857. The latter are produced by polymerising at least 30 wt. % ethylene, at least about 30 wt. % α-olefin, such as e.g. propylene, 1-butene, octene, hexene and optionally 0.5 to 15 wt. % of an unconjugated diolefinic component. In general diolefins having at least five carbon atoms such as 5-ethylidene norbornene, dicyclo pentadiene, 2,2,1-dicyclo pentadiene and 1,4-hexadiene are used as the ter component. Polyalkylene amers such as polypentamer, polyoctenamer, polydodecanamer or mixtures of these are also suitable. Finally, partially hydrogenated polybutadiene rubbers in which at least 70% of the residual double bonds are hydrogenated, are also possible. In general, EP(D)M rubbers have a Mooney viscosity (ML1-4(100° C.) of 25 to 120. They may be obtained commercially. Furthermore, polyolefin elastomers or ethene/octene polyolefins similar to those offered under the commercial name Engage, may be used. Vinyl aromatics and/or core-substituted vinyl aromatics and vinyl cyanides and/or (meth)acrylic acid-(C₁-C₈)-alkyl esters are grafted on.

Graft polymers of

C1) 5 to 95 wt. %, preferably 10 to 80 wt. %, in particular 20 to 50 wt. %, of at least one vinyl monomer on

C2) 95 to 5 wt. %, preferably 90 to 20, in particular 80 to 20 wt. % of one or more grafting bases having glass transition temperatures of the rubber component of <0° C., preferably <−20°, in particular <−40° C., based on EP(D)M rubbers

are preferred.

The grafting base C2) generally has an mean particle size (d₅₀ value) of 0.05 to 5 μm, preferably 0.10 to 2 μm, in particular 0.15 to 1 μm.

Monomers C1) are preferably mixtures

C1.1) of 50 to 99, preferably 60 to 80 parts by weight vinyl aromatics and/or core-substituted vinyl aromatics such as styrene, α-methyl styrene, p-methyl styrene, p-chlorostyrene and/or methacrylic acid-(C₁-C₈)-alkyl ester, such as methyl methacrylate and ethyl methacrylate and

C1.2) 1 to 50, preferably 40 to 20 parts by weight vinyl cyanides (unsaturated nitriles such as acrylonitrile and methacrylonitrile) and/or (meth)acrylic acid —(C₁-C₈)-alkyl esters such as methyl methacrylate, n-butyl acrylate, t-butyl acrylate and/or derivatives, such as anhydrides and imides of unsaturated carboxylic acids, for example maleic acid anhydride and N-phenyl maleimide.

Particularly preferred monomers C1.1) are selected from at least one of the monomers styrene, α-methyl styrene, methyl methacrylate, particularly preferred monomers C2.2) are selected from at least one of the monomers acrylonitrile, maleic acid anhydride and methyl methacrylate.

The graft polymer based on EP(D)M may be produced for example by producing a solution of the EP(D)M elastomer in the monomer mixture and optionally inert solutions and carrying out the grafting reaction at higher temperatures using radical starters such as azo compounds or peroxides. The processes of DE-AS 23 02 014 and DE-A 25 33 991 are mentioned by way of example. It is possible to carry out the process in a suspension as in U.S. Pat. No. 4,202,948 or in mass.

AES rubbers, as disclosed in EP-A1 0 502 237 are preferred in particular. Such AES rubbers may be obtained for example under the name Blendex WX 270 from Ube Cycon Ltd, Tokyo, Japan or Royaltuf 374 from Uniroyal, Great Britain or AES 665 from Techno Polymers Tokyo, Japan.

The thermoplastic molding compositions may contain, as component D), a filler or reinforcing material or a mixture of two or more different fillers and/or reinforcing materials, for example based on talc, mica, silicate, quartz, titanium dioxide, wollastonite, kaolin, amorphous silicas, magnesium carbonate, chalk, feldspar, barium sulfate, glass beads and/or filling materials in fiber form and/or reinforcing materials such as carbon fibers and/or glass fibers. Mineral fillers in particle form based on talc, mica, silicate, quartz, titanium dioxide, wollastonite, kaolin, amorphous silicas, magnesium carbonate, chalk, feldspar, barium sulfate and/or glass fibers are preferred. Mineral fillers in particle form based on talc, wollastonite and/or glass fibers are preferred in particular according to the invention. Fillers based on talc are most preferred.

Particularly for applications, in which isotropy in dimensional stability and high thermal dimensional stability are required, such as for example automotive applications for external bodywork parts, mineral fillers are preferred, in particular talc, wollastonite or kaolin.

Acicular mineral fillers are also preferred in particular. Acicular mineral fillers according to the invention are understood to mean mineral fillers with a highly-distinctive acicular character. Examples are acicular wollastonites. The mineral preferably has a length:diameter ratio of 2:1 to 35:1, particularly preferably of 3:1 to 19:1, most preferably of 4:1 to 12:1. The average particle size of the acicular minerals according to the invention is preferably less than 20 μm, particularly preferably less than 15 μm, in particular less than 10 μm and most preferably less than 5 μm measured with a CILAS GRANULOMETER.

Mineral fillers comprising talc or talcum are most preferred as Component D). All particle-form fillers, which are offered commercially and which contain, in their product description as characterising features, the terms talc or talcum may also be used.

Mineral fillers which have a talc content (determined according to DIN 55920) greater than 50 wt. %, preferably greater than 80 wt. %, particularly preferably greater than 95 wt. % and in particular greater than 98 wt. % in relation to the total quantity of filler are preferred.

The mineral fillers based on talc may also be surface-treated. They may, for example, be treated by a coupling agent system e.g. based on silane.

The mineral fillers based on talc according to the invention preferably have a maximum particle, that is grain size d97 of less than 50 μm, preferably less than 10, particularly preferably less than 6, in particular less than 2.5 μm. A value less than 10, preferably less than 6, particularly preferably less than 2 and in particular less than 1 μm is preferably selected as the average grain size d50. The d97 and d50 values of the fillers D are measured by SEDIGRAPH D 5 000 sedimentation analysis or by DIN 66 165 sieve analysis.

The average aspect ratio (diameter to thickness) of the particle-form fillers based on talc is preferably in the range of 1 to 100, particularly preferably 2 to 25 and in particular 5 to 25, determined on electron-microscopic images of ultra-thin sections of the finished products and measurement of a representative quantity (ca 50 of the filler particles).

The filler and/or reinforcing material may be surface modified, for example with a bonding agent or bonding agent system e.g. based on silane. Particularly when using glass fibers, polymer dispersions, film-formers, branching agents and/or glass fiber processing auxiliary substances may be used in addition to silanes.

Glass fibers are also preferred according to the invention, which generally have a fiber diameter of 7 to 18, preferably 9 to 15 μm, which may be added as continuous fibers or as cut or ground glass fibers, and the fibers may include suitable sizing system and a bonding agent or bonding agent system e.g. based on silane.

Common silane compounds for pre-treatment have, for example, the general formula

(X—(CH2)q)k-Si—(O—CrH2r+1)4−k

in which

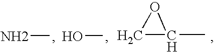

x is any of

q an integer from 2 to 10, preferably 3 to 4

r an integer from 1 to 5, preferably 1 to 2

k an integer from 1 to 3, preferably 1.

Preferred silane compounds are aminopropyl trimethoxy silane, aminobutyl trimethoxy silane, aminopropyl triethoxy silane, aminobutyl triethoxysilane and the corresponding silanes, which contain a glycidyl group as substituent X.

The silane compounds are generally used in quantities of 0.05 to, preferably 0.5 to 1.5 and in particular 0.8 to 1 wt. % in relation to the mineral filler for surface coating.

The fillers in particle form may have a smaller d97 or d50 value in the molding composition or molded body than the filler originally used as a result of processing to produce the molding composition or molded body. The glass fibers may have shorter length distributions in the molding composition or molded body than those originally used as a result of processing to produce the molding composition or molded body.

The particle diameter of the filler in the finished product may be determined for example from electron-microscopic images of thin sections of the polymer mixture and using at least 25, preferably at least 50 filler particles for the evaluation.

According to the invention, the compositions may contain, as component E), conventional coloring agents and/or pigments such as e.g. titanium dioxide, ultramarine blue, iron oxide, carbon black, phthalocyanine, quinacridone, perylene, nigrosin and anthraquinone and derivatives of these. The coloring agents and/or pigments may be added without solvent or as master batches for example in component A), component B), component C), polyethylene, polypropylene, waxes or paraffin.

The compositions according to the invention may also contain, as component F), functional additives, in general up to 15, which are added preferably in a quantity of 0.01 to 10, particularly preferably 0.05 to 5, in particular 0.1 to 3 wt. % in relation to the total weight of the molding compositions.

All functional additives such as e.g. stabilizers (for example UV stabilizers, thermal stabilizers), anti-statics, flow auxiliary substances, mold release agents, fire-protection additives, emulsifiers, nucleating agents, plasticizers, mold lubricants, pH-reducing additives (e.g. compounds containing carboxyl groups), additives to increase conductivity, may be used. These and other suitable additives are disclosed for example in Gächter, Müller, Kunststoff-Additive, 3^{rd} Edition, Hanser-Verlag, Munich, Vienna, 1989. The additives may be used alone or in mixture or in the form of masterbatches. The additives may be admixed and/or applied to the surface.

Sterically hindered phenols and/or phosphites, hydroquinones, aromatic secondary amines such as diphenyl amines, substituted resorcinols, salicylates, benzotriazols and benzophenones, as well as variously-substituted representatives of these groups and mixtures thereof, for example, may be used as stabilizers.

Sodium phenyl phosphinate, aluminium oxide, silicon dioxide and preferably talcum, and the nucleating agents described earlier may be used e.g. as nucleating agents.

Ester waxes, pentaerythritol tetrastearate (PETS), long-chain fatty acids (e.g. stearic acid or behenic acid), their salts (e.g. Ca or Zn stearate) and amide derivatives (e.g. ethylene-bis-stearyl amide) or montan waxes (mixtures of straight-chain, saturated carboxylic acids with chain lengths of 28 to 32 C atoms) and also low-molecular polyethylene- or polypropylene waxes, may be used as mold lubricants and mold release agents.

Phthalic acid dioctyl esters, phthalic acid dibenzyl esters, phthalic acid butyl benzyl esters, hydrocarbon oils, N-(n-butyl)benzene sulfonamide, for example, may be used as plasticisers.

To obtain conductive molding compositions, carbon blacks, conductive carbon blacks, carbon fibrils, nanoscale graphite fibers (nanotubes), graphite, conductive polymers, metal fibers and other conventional additives may be added to increase conductivity.

Commercial organic halogen compounds containing synergists or commercial organic nitrogen compounds or organic/inorganic phosphorus compounds may be used individually or in mixture as flame retardants. Mineral flame retarding additives such as magnesium hydroxide or Ca—Mg-carbonate hydrate (e.g. DE-A 4 236 122) may also be used. The following are given as examples of halogen-containing, in particular brominated and chlorinated, compounds: ethylene-1,2-bistetrabromo phthalimide, epoxidated tetrabromo bisphenol A resin, tetrabromo bisphenol A oligocarbonate, tetrachloro bisphenol A oligocarbonate, pentabromo polyacrylate, brominated polystyrene. The phosphorus compounds according to WO-A 98/17720 (PCT/EP/05705) are suitable as organic phosphorus compounds, e.g. triphenyl phosphate (TPP), resorcinol-bis-(diphenyl phosphate) including oligomers and also bisphenol A-bis-diphenyl phosphate including oligomers (cf. e.g. EP-A 363 608 and EP-A 640 655), melamine phosphate, melamine pyrophosphate, melamine polyphosphate and mixtures of these. Melamine and melamine cyanurate are possible in particular as nitrogen compounds. Antimony compounds, in particular antimony trioxide and antimony pentoxide, zinc compounds, tin compound such as e.g. tin stannate and borate, for example, are suitable as synergists. Carbon formers and tetrafluoroethylene polymers may be added. The flame retardants, optionally containing a synergist, such as antimony compounds and anti-dripping agents, are generally used up to a quantity of 30, preferably 20 wt. % (in relation to the total composition).

Reinforcing materials e.g. in the form of glass fibers may also be added as additives.

The invention also provides a process for the production of the compositions, the use of the compositions according to the invention for the production of semi-finished products and molded parts and the semi-finished products and molded parts produced from them.

The compositions according to the invention are produced by mixing the components using processes known per se. It may be advantageous to pre-mix individual components. Components A to D and other components are preferably mixed at temperatures of 220 to 330° C. by kneading, extruding or rolling the components together.

The compositions according to the invention may be processed by the conventional processes to form semi-finished products or molded parts of all kinds. Examples of processing methods are extrusion and injection molding. Examples of semi-finished products are films and sheets.

Because of their great homogeneity of color, the molded parts are suitable for applications that are visible and optically significant. The molded parts may be used according to the invention un-lacquered or coated with a transparent clear lacquer system. The molded parts may be small or large and may be used for external or internal applications. Large molded parts are preferably produced for vehicle construction, in particular in the automobile sector. External bodywork parts in particular may be manufactured from the molding compositions according to the invention, such as e.g. mudguards, tail gates, bonnets, bumpers, loading areas, covers for loading areas, car roofs, air intake grilles, spoilers or other bodywork components.

Molded parts or semi-finished products made of the molding compositions according to the invention may also be found in composites with other materials such as e.g. metal or plastic. The molding compositions according to the invention or the molded parts/semi-finished products made from the molding compositions according to the invention may be used by means of the conventional techniques for connecting and joining several components or parts such as e.g. coextrusion, film back spraying, spray coating of union ends, gluing, welding, screwing or clamping in composite structures with other materials or themselves for the production of finished parts such as e.g. external bodywork parts.

The molding compositions according to the invention may also be used for numerous other applications. Examples are the use in electrics and electronics and in the building industry. In the stated applications, molded parts made of the molding compositions according to the invention may be used for example as lamp covers, safety screens, as a case material for electronic devices, as a case material for domestic appliances, as sheets for the production of covers.

The compositions according to the invention are characterized by very good homogeneity of color. In addition they fulfil the strict requirements for processing stability, flowability of the melt, toughness, low-temperature toughness, stiffness, thermal stability , thermal expansion, surface quality, lacquerability, resistance to chemicals and resistance to fuels.

### EXAMPLES

Component A

Polyethylene terephthalate type A1: this is polyethylene terephthalate with an intrinsic viscosity IV of 0.74 cm³/g and an isothermal crystallisation time at 215° C. of ca 4.2 minutes.

The intrinsic viscosity is measured in phenol/0-dichlorobenzene (1:1 parts by weight) at 25° C.

The isothermal crystallisation time of PET is measured by the DSC method (differential scanning calorimetry) with a PERKIN ELMER DSC 7 Differential Scanning Calorimeter (weighed portion ca 10 mg, perforated Al pan) with the following temperature programme:

1. Heating up from 30° C. to 290° C. at 40° C./min,

2. 5 min. isothermal at 290° C.

3. Cooling from 290° C. to 215° C. at 160° C./min,

4. 30 min isothermal at 215° C. (crystallisation temperature).

The evaluation software is PE Thermal Analysis 4.00.

Component B

Linear polycarbonate (Makrolon 2805 from Bayer AG, Leverkusen, Germany) based on bisphenol A with a viscosity ηrel. of ca 1.29 (measuring conditions: 5 g polycarbonate per litre methylene chloride, 25° C.) and a molecular weight M_{w} of ca 29 000 g/mol (determined by GPC methods against polycarbonate standard).

Component C1

The AES graft polymer used is Blendex WX 270 from Ube Cycon Ltd., Tokyo, Japan.

Acrylate Rubber 1

The acrylate graft polymer used in the comparative examples is Paraloid EXL 2300 from Rohm und Haas Deutschland GmbH, Frankfurt.

Acrylate Rubber 2

The acrylate graft polymer used in the comparative examples is Paraloid EXL 3361 from Rohm und Haas Deutschland GmbH, Frankfurt.

Acrylate Rubber 3

The acrylate graft polymer used in the comparative examples is Paraloid EXL 2314 from Rohm und Haas Deutschland GmbH, Frankfurt.

Component E

A 50% carbon black masterbatch in polyethylene available as Ruβ Plasblack PM 3798 (commercial product of Cabot) was used as a coloring agent.

A mixture of conventional stabilizers, nucleating agents and mold release agents was used as the additive for Component F.

Compounding was carried out in a twin shaft extruder of the type ZSK32 (Werner und Pfleiderer) at composition temperatures of 250 to 290° C.

The test specimens were injection molded on an Arburg 320-210-500 injection molding machine at composition temperatures of 260 to 280° C. and mold temperatures of 70 to 90° C.

The molding compositions according to the invention were tested according to the following methods:

Vicat B: thermal resistance determined according to DIN ISO 306/B 120 in silicon oil.

Izod impact resistance: determined according to ISO 180 method 1 U at −23° C.

Izod notched impact resistance: determined according to ISO 180 method 1 A at 23° C.

Tensile modulus: determined according to DIN/EN/ISO 527-2/1A.

Elongation at break: determined according to DIN/EN/ISO 527-2/1A.

MVR: flowability determined according to DIN/ISO 1133 at 280° C. and 2.16 kg.

Homogeneity of color: Determination by visual inspection.

“+” means homogeneous coloring without the formation of stripes of lesser color intensity perpendicular to the direction of flow

“∘” means largely homogeneous coloring with slight formation of stripes of lesser color intensity perpendicular to the direction of flow

“−” means inhomogeneous coloring with marked formation of stripes perpendicular to the direction of flow.

Homogeneity of color was determined on 150×105×1.6 mm sheets, which were produced at a melt temperature of 270° C., a mold temperature of 80° C. and a fill speed of 50 mm/s through a film feed on one 105 mm side.

As can be seen from Table 1, the molding compositions according to the invention have very good homogeneity of color and at the same time good mechanical properties. In comparison with the reference examples Ref. 1 and Ref. 3, which have poorer homogeneity of color, the toughness of Ref. 1 and Ref. 3 was exceeded by Example 2 even with a reduced content of AES rubber.

The composition and properties of the thermoplastic molding compositions according to the invention may be seen in Table 1.

TABLE 1

| | | Examples | | | | |
|---|---|---|---|---|---|---|
| | | Ex. 1 | Ex. 2 | Ref. 1 | Ref. 2 | Ref. 3 |
| Component A | [%] | 37.9 | 39.9 | 37.9 | 37.9 | 37.9 |
| Polyethylene terephthalate | | | | | | |
| Component B | | 50.0 | 50.0 | 50.0 | 50.0 | 50.0 |
| Polycarbonate | | | | | | |
| Component C | [%] | 10.0 | 8.0 | — | — | — |
| AES rubber | | | | | | |
| Acrylate rubber 1 | [%] | — | — | 10.0 | — | — |
| Acrylate rubber 2 | [%] | — | — | — | 10.0 | — |
| Acrylate rubber 3 | [%] | — | — | — | — | 10.0 |
| Component E, carbon black | [%] | 1.2 | 1.2 | 1.2 | 1.2 | 1.2 |
| Additives | [%] | 0.9 | 0.9 | 0.9 | 0.9 | 0.9 |
| Vicat B | [° C.] | 129 | 131 | 135 | 135 | 135 |
| Izod impact resistance @ −20° C. | [kJ/m²] | 69 | 59 | 42 | 75 | 34 |
| Izod notched impact resistance @ | [kJ/m²] | 6.5 | 6.3 | 4.3 | 14.1 | 4.2 |
| 23° C. | | | | | | |
| Tensile modulus | [MPa] | 2281 | 2376 | 2334 | 2295 | 2255 |
| Elongation at break | [%] | 11 | 16 | 5 | 30 | 7 |
| MVR (280° C./2.16 kg) | [cm³/10 min] | 20 | 25 | 43 | 24 | 27 |
| Color homogeneity | | + | + | − | − | o |

Although the invention has been described in detail in the foregoing for the purpose of illustration, it is to be understood that such detail is solely for that purpose and that variations can be made therein by those skilled in the art without departing from the spirit and scope of the invention except as it may be limited by the claims.

What is claimed is:

1. A thermoplastic molding composition comprising
A) 4 to 80% of at least one polyalkylene terephthalate,
B) 10 to 90% of at least one aromatic polycarbonate,
C) 1.5 to 30% of at least one AES graft polymer,
D) 0 to 54% of at least one mineral filler in particulate form,
E) 0.01 to 10% of a coloring material,
F) 0 to 10% of at least one functional additive, the percents, all occurrences being relative to the weight of the composition.

2. The composition according to claim 1, wherein C is a graft polymers of
C1) 5 to 95% of at least one vinyl monomer
C2) 95 to 5% of one or more grafting bases of EP(D)M having glass transition temperatures of the rubber component <0°.

3. The composition according to claim 1 wherein said polyalkylene terephthalate is polyethylene terephthalate.

4. A molded article comprising the composition of claim 1.
